(19) United States
(12) Patent Application Publication
(10) Pub. No.: US 2015/0352405 A1
(43) Pub. Date: Dec. 10, 2015

(54) AUDIBLE SAFETY AND TRAINING METHOD FOR SPORTING EQUIPMENT

(71) Applicant: TWD Sports Tech LLC, Annapolis, MD (US)

(72) Inventors: Brian TORONTO, Annapolis, MD (US); James H. WELLS, Oolitic, IN (US)

(73) Assignee: TWD Sports Tech LLC, Annapolis, MD (US)

(21) Appl. No.: 14/299,537

(22) Filed: Jun. 9, 2014

(51) Int. Cl. A63B 24/00; G08B 3/10; G09B 19/00; A63B 69/00; G09B 5/04

(52) U.S. Cl. CPC A63B 24/0006; A63B 69/0002; G09B 5/04; G09B 19/0038; G08B 3/10; A63B 2024/0012

(57) ABSTRACT

A method for safety and/or training with an elongated item of sporting equipment has an electronic sports device affixed a gripping end of the sports device such that the sports device and the gripping end move together. The sports device emits first audible signal upon a first rotation of the sports device in a first rotational direction about a longitudinal axis of the equipment and the sports device emits a second audible signal upon a rotation of the sports device in a second, opposite, rotational direction about the longitudinal axis. This informs a user that the equipment is being undesirably rotated during a swinging motion of the equipment through an arc appropriate to the sport associated with the equipment. The user can adjust the next swing in response to hearing such signals. The sports device may also emit a motion signal to warn others that the equipment is in motion.

### FIELD OF THE INVENTION

The present disclosure relates to audible training aids, particularly for use with sporting equipment which is swung, such a through an arc. The training aids of the present disclosure are of a type intended to assist with improvement of personal performance or teach other proper uses of the equipment, such as safety, by producing an audible signal.

### BACKGROUND OF THE INVENTION

Sports have a growing importance for people of all ages. Sports provide an athletic outlet to improve fitness and physical health in a society that is becoming more and more sedentary. Children are spending longer and longer in front of electronics and less and less time with physical activities.

Competing with the goal of promoting sports and other physical activities is the growing concern over both short and long-term injury. More and more effort is being put toward teaching safety, promoting proper technique, and avoiding injury at a young age. Examples include the use of stop-sign decals sewn on the back of hockey jerseys to remind players not to check other players from behind. Football coaches have increased focus on tackling fundamentals to avoid head injuries. Significant research has been conducted into limiting the types and quantity of pitches thrown by Little Leaguers to avoid strain on young arms.

In addition, the competitive landscape has also continued to increase, whether athletic competition to win championships and play for the best teams; or academic competition to be accepted into the most prestigious educational programs. Therefore there is a need for tools to help individuals excel and improve their performance. Several training tools exist that are designed to improve an athlete's swing or hand-eye coordination in sports such as baseball, golf or tennis. However, many of these tools require large assemblies that must be constructed and deconstructed to be moved from one location to another. Other tools require expensive equipment, such as cameras, which record a player's motion and then must be reviewed by the player at a later time.

### SUMMARY OF THE INVENTION

With the trends discussed above in mind, the inventors have developed a safety and training device for use with sporting equipment that can help promote the safe use of sporting equipment and promote the preferred technique when using sporting equipment.

One aspect of the present disclosure is to promote proper technique when using sporting equipment. Particularly, the device of the present disclosure promotes a swing of an elongated sporting implement, such as a baseball bat or golf club, without rotation of the implement about its longitudinal axis.

Another aspect of the present disclosure is to promote the safe use of sporting equipment by emitting an audible warning signal when the equipment is in motion. The warning signal is intended to reduce injury to those in the vicinity by indicating use of the equipment in the area.

Another aspect of the present disclosure is to provide an electronic device that is suitable for promoting the training and safety features discussed above. By combining sports with electronics, children and persons of any age may be prompted to safely practice and improve their performance in the respective sport.

With these and other aspects in mind, the present disclosure provides a method for either or both assisting an individual to improve his or her swing of an elongated item of sporting equipment and providing a warning to others in the vicinity of the equipment. The method involves emitting sounds to train one to properly use the device, and also to warn others in the vicinity of the equipment. An electronic device attachable to, or integrated with, elongated sporting equipment is configured to emits the sounds under certain predetermined conditions to serve either or both as a training device and as a safety device for alerting others that the equipment is moving.

In yet another aspect, the invention is directed to an electronic safety device for alerting others to the motion of an elongated item of sporting equipment having a gripping end, a far end and a longitudinal axis. The safety device includes a housing mountable to the gripping end of the equipment, the housing accommodating a motion sensor, a processor; and an audio device operatively connected to the processor. When so mounted, motion of the equipment results in motion of the safety device, which latter motion is sensed by the motion sensor. The processor, in turn, is configured to trigger the audio device upon sensing motion to thereby produce an audible motion signal The audible motion signal acts to alert others nearby to the presence of a moving item of sporting equipment.

In the electronic safety device, the audio device may emit noise only when the motion exceeds a predetermined minimal acceleration threshold. The minimal acceleration threshold may be 0.08 g.

In the electronic safety device, the motion sensor may be capable of sensing translational motion in three dimensions and rotational motion about at least one axis.

In still another aspect, the invention is directed to the aforementioned electronic safety device in combination with an elongated item of sporting equipment, the safety device being mounted at the gripping end of the elongated item of sporting equipment, along the latter's longitudinal axis. The elongated item of sporting equipment may be a baseball bat, a lacrosse stick, a tennis racket, a golf club, or the like.

In the aforementioned electronic safety device combination, the audible motion signal may be emitted only when the equipment is swung by its gripping end.

In yet another aspect, the invention is directed to an electronic training device for attachment to an elongated item of sporting equipment having a gripping end, a far end and a longitudinal axis. The training device includes a housing mountable to the gripping end of the equipment, the housing accommodating a motion sensor, a processor; and an audio device operatively connected to the processor. When so mounted, motion of the equipment results in motion of the training device, which latter motion is sensed by the motion sensor. The training device, when mounted on the equipment, is configured to emit one or more audible signals when the equipment is rotated about its longitudinal axis. Rotation of the equipment about the longitudinal axis in a first direction triggers the audio device to emit a first audible signal and rotation of the equipment about the longitudinal axis in a second direction opposite the first direction triggers the audio device to emit a second audible signal distinct from the first audible signal.

In the electronic training device, the first and second audible signals are emitted only upon rotation of the equipment by more than a predetermined angular extent and within a predetermined period of time. The minimum angular extent may be plus or minus 8 degrees.

In the electronic training device, the motion sensor is capable of sensing translational motion in three dimensions and rotational motion about at least one axis.

The aforementioned electronic training device may also have a safety feature. In such case the processor, is additionally configured to trigger the audio device upon sensing motion to thereby produce an audible motion signal The audible motion signal acts to alert others nearby to the presence of a moving item of sporting equipment.

In such an electronic training device provided with a safety feature, the audio device may emit noise only when the motion exceeds a predetermined minimal acceleration threshold. The minimal acceleration threshold may be 0.08 g.

In such an electronic training device provided with a safety feature, motion sensor may be capable of sensing translational motion in three dimensions and rotational motion about at least one axis.

In still another aspect, the invention is directed to a method for informing a runner of excessive pronation or supination of a foot during a stride. The method comprises affixing a sports device to a dorsal portion of each shoe or foot of the runner such that the sports device and the shoe or foot move together. Each sports device is configured to: output a first audible signal when a medial yaw of the shoe or foot exceeds a first predetermined angular extent; and output a second audible signal distinct from the first audible signal, when a lateral yaw of the shoe or foot exceeds a second predetermined angular extent.

### BRIEF DESCRIPTION OF THE DRAWINGS

In the accompanying drawings, the preferred embodiment of the invention and preferred methods of practicing the invention are illustrated in which:

FIG. 1 shows an example environment in which embodiments of the present invention may be used.

FIG. 2A shows an isometric cut-away view of an example embodiment of a device according to the present disclosure.

FIG. 2B shows a cross-section view of an example embodiment of a device according the present disclosure.

FIG. 3 shows a flow chart reflective of a safety mode of the device of the present invention.

FIG. 4 shows a flow chart reflective of a training mode of the device of the present invention.

FIG. 5 shows a flow chart reflective of a combination mode of the device of the present invention.

### DETAILED DESCRIPTION

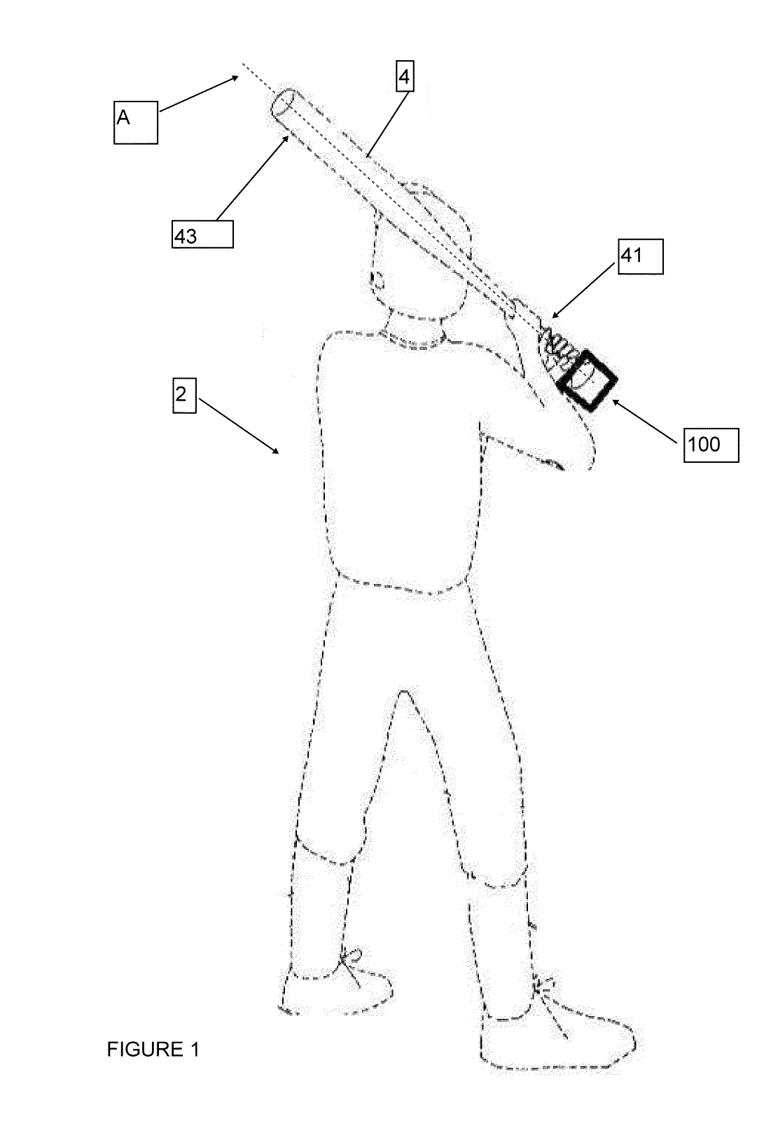

Referring now to the drawings wherein like reference numerals refer to similar or identical parts throughout the several views, FIG. 1 shows an example environment in which embodiments of the present invention may be used.

A baseball player 2 may have sporting equipment 4, such as a bat. The equipment 4 is elongated in shape, thereby having a longitudinal axis A running along the bat. The equipment 4 includes a gripping end 41 and a far end 43. The far end 43 is often referred to as the head of a baseball bat or the head of a golf club. An electronic sports device 100 (referred to herein also as a “training device” or “safety device”, as appropriate) according to the present invention is attached to the equipment 4 in a manner that movement of the equipment 4 by the player 2 will directly translate to movement of the sports device 100.

As illustrated in FIG. 1, the sports device 100 can be mounted to the sporting equipment 4 at the gripping end 41 thereof. Further, the sports device 100 can be mounted at the gripping end 41 such that the longitudinal axis A of the equipment 4 passes through the sports device 100. The arrangement shown in FIG. 1 is an example only. The sports device 100 could be mounted to the far end 43, or virtually anywhere along the equipment 4. The sports device 100 can be mounted such that the longitudinal axis A of the equipment 4 does not pass through the sports device 100. While several mounting arrangements are within the scope of this disclosure, some embodiments of the sports device 100 may be designed to mount to a predetermined location, at a predetermined orientation, to ensure proper functioning of the sports device 100.

In the preferred embodiments, the sports device 100 is removably attached to the sporting equipment 4. Removable attachment allows for the sports device 100 to be shared among teammates and allows the sports device 100 to be used during a practice setting, but removed during competition. Preferably the removable attachment of the sports device 100 is such that the sports device 100 can be nearly universally attached to any similar item of sporting equipment 4. For example, the sports device 100 can be attachable to nearly any bat, or can even be removably attachable to tennis rackets and golf clubs, given appropriate mounting adapters and related hardware.

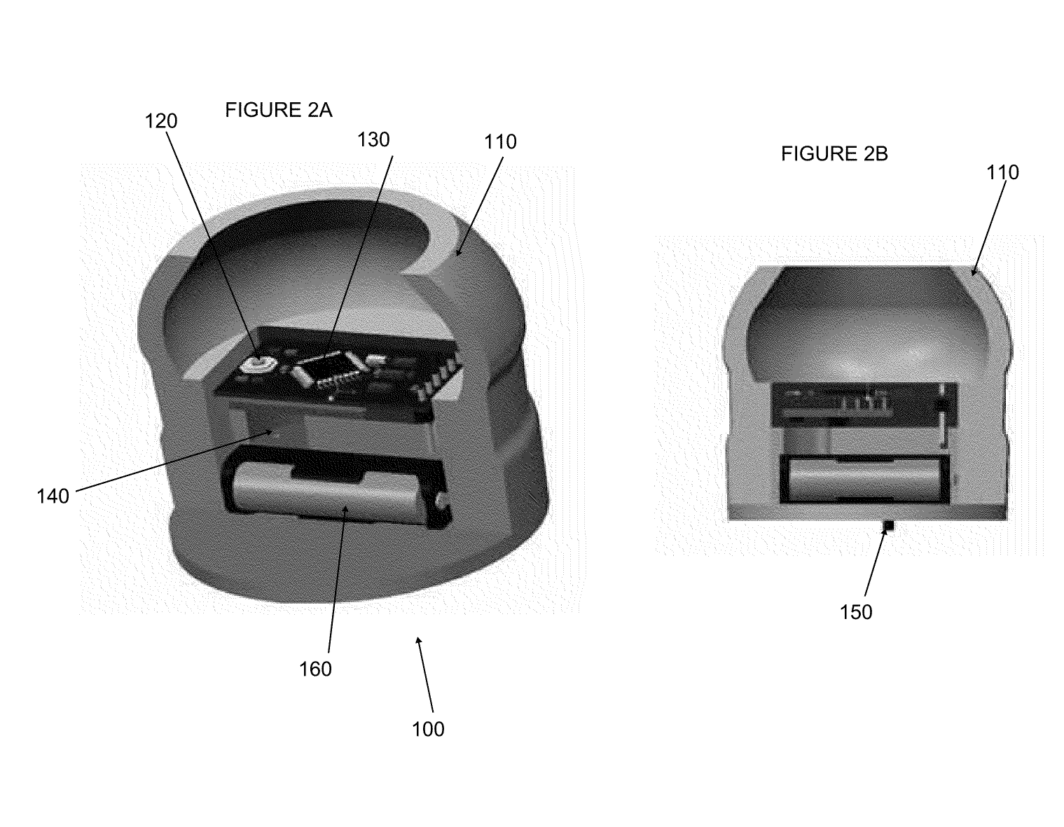

As seen in FIGS. 2A and 2B, the sports device 100 includes a housing 110 to be removably attached to the sporting equipment 4. The housing 110 of the illustrated embodiment provides a clam shell design that is molded to close around the equipment 4 at the desired location, such as the knob of a baseball bat at the gripping end 41. The clam shell may be held together with one of several known fasteners such as clips, screws, belts, bands, buckles, hook and loop fasteners and the like. The housing 110 could also take other forms, such as a sleeve configured to slide over an end of the equipment 4. The sleeve could then be secured to the equipment 4 by any of several known methods such as friction, tie-down, hook and loop fasteners, set screws and the like.

Preferably, the housing 110 should be constructed to be durable and resist damage to itself, and any components positioned therein, during normal use. Sporting equipment 4 is expected to be handled roughly, including being tossed to the ground. Therefore the sports device 100 should also be able to avoid damage when tossed to the ground along with the equipment 4. The housing 110 can be molded or otherwise formed from durable materials such as plastics. In some embodiments the housing 110 can itself include a protective sleeve or covering, from materials such as rubber, that would further protect the sports device 100 from impact.

The sports device 100 includes several components positioned at least partially within the housing 110. Those components include a motion sensor 120, a programmable processor 130, an audio device 140, a switch 150, and a power source 160.

The motion sensor 120 is configured to repeatedly test for motion of the sports device 100. The motion sensor 120 should be capable of detecting motion in all three dimensions as well as rotational motion. Preferably this capability is provided by a three-dimensional accelerometer and a gyro-meter. These may be provided as separate elements or combined in a single component. Suitable motion sensors 120 may include the KOOTEKk® GY-521 MPU6050.

The sports device 100 can be controlled by a programmable processor 130. The processor 130 can be programmed to translate movement signaled by the motion sensor 120 into the desired output signal for use by the audio device 140. A suitable processor can include the Nano, available from Arduino. It is understood that other processors may be used, and/or the sensor and the processor may be combined in an ASIC or the like.

Various embodiments of the sports device 100 are configured to provide an auditory warning signal for safety purposes and/or one or more auditory indicator signals for training purposes. Therefore, the sports device 100 should include an audio device 140. The audio device 140 may be a speaker or buzzer as available in the art. For example, piezo-buzzers may be used. The strength of the audio device 140 should be selected so that its audio signal can be clearly heard by others in the vicinity of the player 2 when the sports device 100 is used in outdoor environments with significant ambient noise. In some embodiments, the audio device 140 can be mounted within the housing 110 adjacent to an opening in the housing 110. This configuration would promote the sound generated by the audio device 140 leaving the housing 110. While use of an audio device 140 to produce audible signals is believed to be preferred, one or more illumination devices such as light emitting diodes may be used to provide a visual signal in addition to or in place of the audio device 140.

A switch 150 may be provided with the sports device 100. The switch 150 may be mounted to the housing 110 so that it is accessible from outside of the housing 110. The switch 150 may take several forms. The switch 150 preferably provides an on/off function at a minimum. The switch 150 may provide the on/off function based upon manual manipulation or may be automatic. For example, the switching function may be between “on” and “standby” as opposed to a hard “off.” In the former embodiment, the motion sensor 120 can continuously be receiving power in the “standby” mode and switch to “on,” where audible signals are provided as necessary, upon first movement of the sports device 100. The sports device 100 could then switch back to “standby” after a predetermined time period without motion being sensed. The “standby” feature described above can also be programmed into the processor 130 even with a switch 150 that provides a hard “off.” The switch 150 may also provide the sports device 100 with a mode selection function to select between several modes as discussed below.

In some embodiments, a multi-position switch may be used to select from among a plurality of operation modes. In a first mode of operation, only the training feature may be activated. In a second mode of operation both the training feature and the safety feature may be activated. In a third mode of operation only the safety feature may be activated. It is understood that in some embodiments only two of these modes may be possible.

The housing 110 should also be configured to accommodate a power source 160 capable of powering at least the motion sensor 120, processor 130 and audio device 140. The power source 160 may be a battery replaceably mounted within a batter holder case wired to the other components.

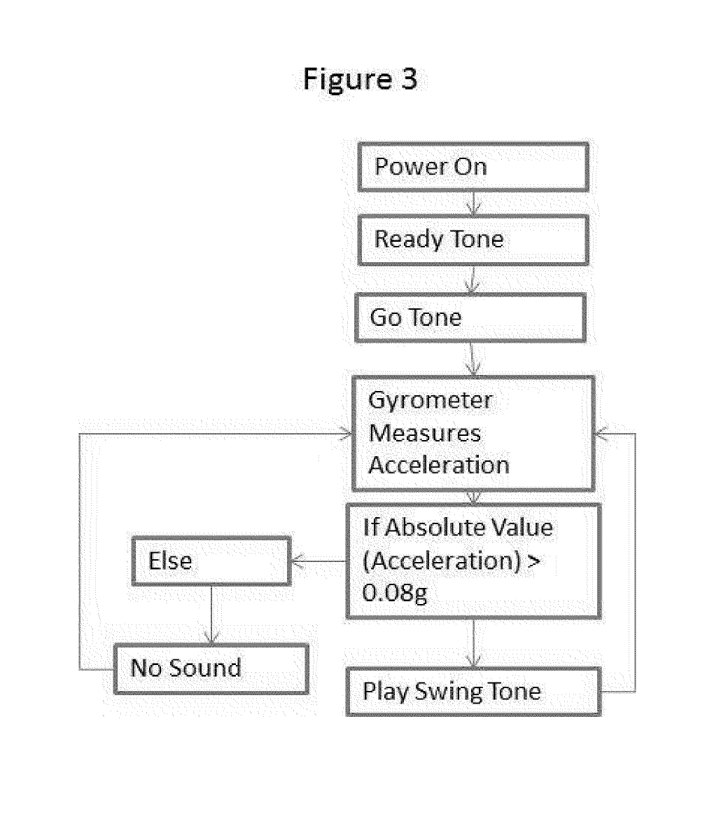

FIG. 3 illustrates an example flow chart of the function of the sports device 100 in connection with the sporting equipment 4 in a safety mode. After powering on the sports device 100 with switch 150, a “ready tone” may sound, providing the player 2 with an indication that the sports device 100 is active.

At this point, the processor 130 can be programmed to introduce a delay. This delay would provide the player 2 with time to position themselves and the equipment 4 in position for swinging. At the end of the delay, values for motion and angle can be zeroed or neutralized and a “go tone” can sound.

Power from the power source 160 is routed into the processor 130 which then sends some of the current to the motion sensor 120, which repeatedly checks for changes in acceleration. Movement that causes a resultant acceleration larger than a predetermined minimum threshold, for example 0.08 g, will cause the audio device 140 to signal the start of motion with a “motion tone”. If the motion sensor 120 does not detect a change in velocity (i.e., motion), then the processor 130 will not provide a voltage to the audio device 130, resulting in no motion tone.

Emission of the “motion tone” provides the aforementioned safety feature. The “motion tone” should be audible not only to the player 2, but also to any others in the vicinity of the player 2. The vicinity would include anyone within reach of the player 2 holding the sporting equipment 4 on which the sports device 100 is mounted. The vicinity may also be expanded to beyond this reach, creating additional factors of safety. The preferred result is that anyone hearing the “motion tone” would know that the sporting equipment 4 is in motion nearby and the hearer should be made attentive to their surroundings and remain a safe distance from the equipment 4.

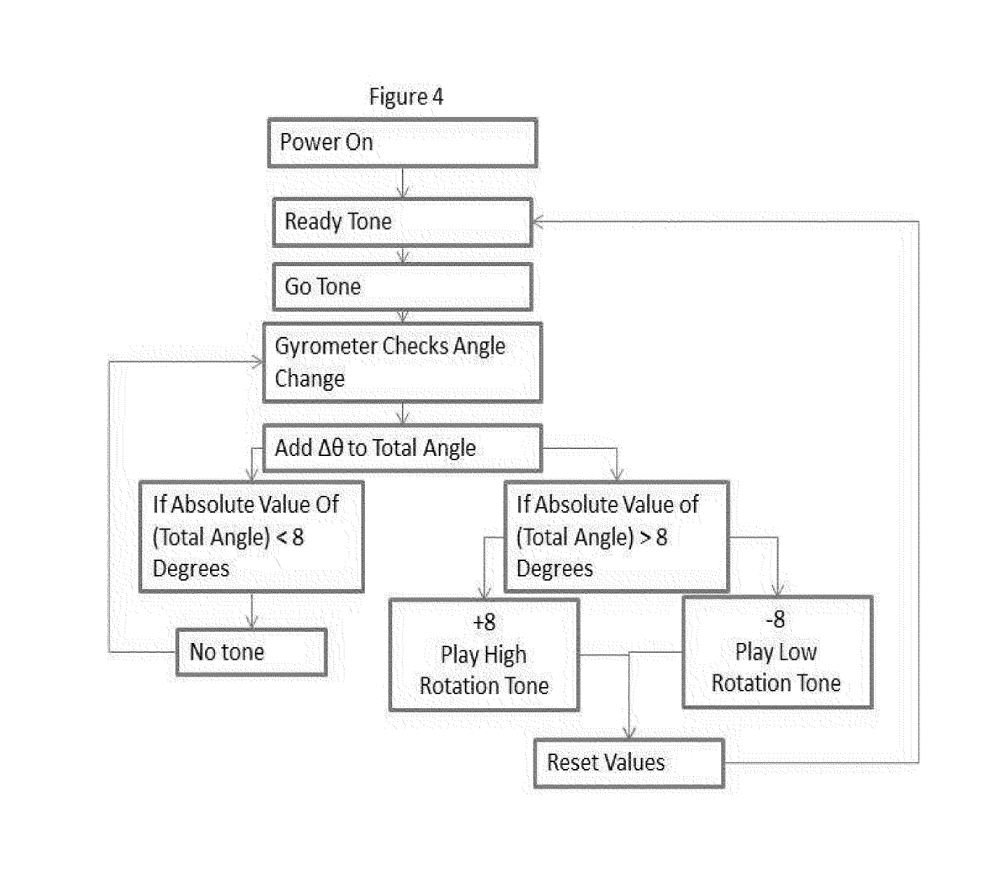

FIG. 4 illustrates an example flow chart of the function of the sports device 100 in connection with the sporting equipment 4 in a training mode.

After powering on the sports device 100 with switch 150, a “ready tone” may sound, providing the player 2 with an indication that the sports device 100 is active.

At this point, the processor 130 can be programmed to introduce a delay. This delay would provide the player 2 with time to position themselves and the equipment 4 in position for swinging. At the end of the delay, values for motion and angle can be zeroed or neutralized and a “go tone” can sound.

Power from the power source 160 is routed into the processor 130 which then sends some of the current to the motion sensor 120, which repeatedly checks for changes in angle of orientation. The processor 130 can be configured to record values of angle change along at least one axis, preferably at least an axis generally parallel with the longitudinal axis A of the sporting equipment 4, when the sports device 100 is mounted to the equipment 4.

If the player 2 rotates the equipment 4 about its longitudinal axis A in either direction by more than a threshold amount, at least one rotation tone will be emitted from the audio device 140. In some embodiments, the threshold amount of rotation is set to +/−8 degrees. In some embodiments, the processor may be programmed such that threshold amount of rotation must take place within a predetermined amount of time (i.e., the rotation must be ‘fast enough’) before a tone is emitted.

In some embodiments, two rotation tones can be generated; a first rotation tone corresponding to rotation in a first direction and a second rotation tone corresponding to rotation in a second, opposite direction. In some embodiments, the first rotation tone is a high rotation tone pitched higher than the “motion tone” and the second rotation tone is a low rotation tone pitched lower than the “motion tone.”

If the player 2 should rotate the equipment 4 by +/−8 degrees, the appropriate first or second rotation tone will be emitted. Preferably, once a rotation tone begins, it will continue for a predetermined period sufficient such that the player 2 is aware of what motion has occurred.

After a rotation tone is emitted, the motion sensor 120 and/or the processor 130 are reset and ready to detect improper rotational motion again. The audio device 140 may be signaled to emit the “ready tone” again.

The inventors have found that rotation of a baseball bat along its longitudinal axis, at least while passing through the hitting zone, can negatively affect a player's 2 hitting performance. If the bat is rotating while contacting the ball, the player 2 can experience a reduction in power and an increased likelihood of undesirable contact and accuracy.

Therefore the sports device 100 of the present disclosure, when used in training mode, can assist a player 2 develop a swing with minimal longitudinal axis rotation through the hitting zone. For example, the process of training a baseball player would begin with the player swinging the equipment 4 (e.g. a bat) equipped with the sports device 100 through the player's usual arc for hitting a ball. During the swing the player would be listening for the rotation tones. If the player hears a rotation tone, they can interpret whether the tone they heard was a high tone indicating an excessive first direction of rotation or a low tone indicating excessive rotation in the opposite direction. Then, during subsequent swings, the player can adjust their motion in response to the tone heard, so as to reduce the likelihood of creating one of the rotation tones on the such subsequent swings. The training mode is likely preferred when a player is practicing alone and the function of the safety mode is less desirable.

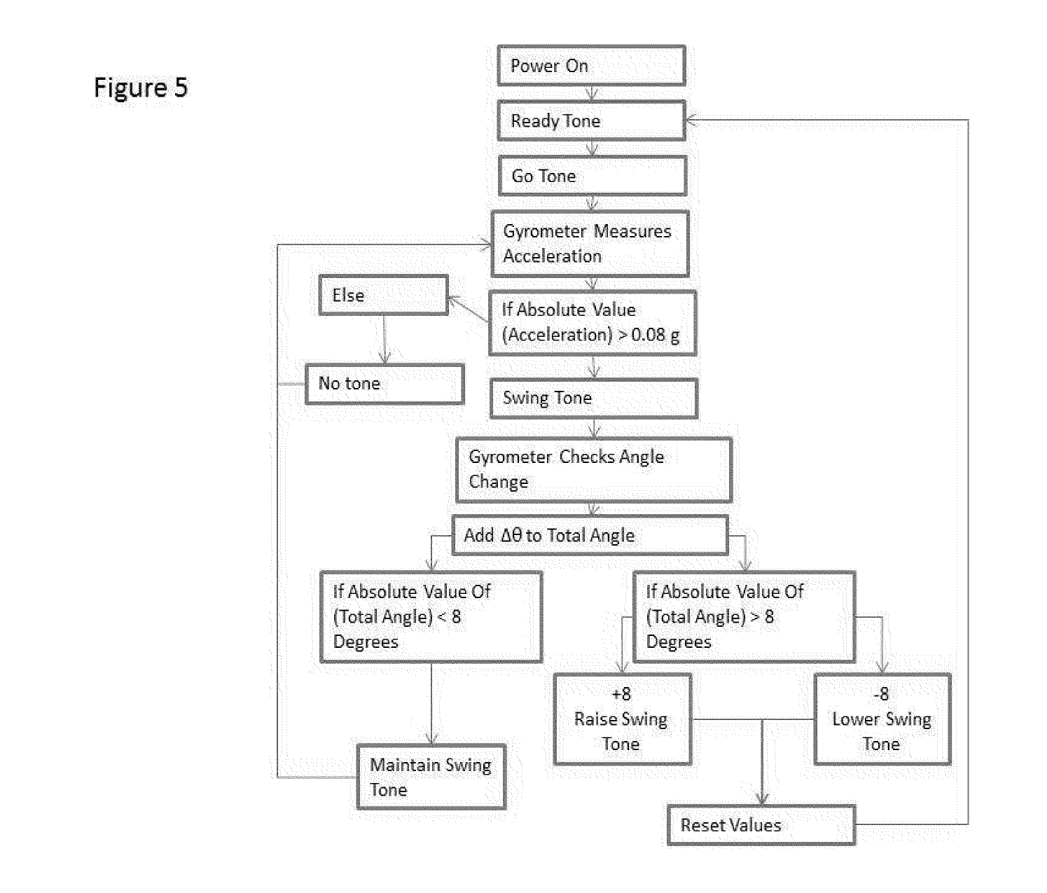

FIG. 5 illustrates an example flow chart of the function of the sports device 100 in connection with the sporting equipment 4 in a combined mode, providing both the features of the safety mode and the features of the training mode.

The combined mode illustrated by the chart of FIG. 5 should be understood from the discussion of the safety mode and the training mode discussed above with respect to FIGS. 3 and 4. Generally, the combined mode can begin similar to the safety mode with the powering on of the device and the possible emission of a “ready tone” when the program of the processor 130 is calibrated. Initiation of a swing, or any sufficient motion, by the player will trigger the beginning of the “motion tone” providing a warning noise to others. While the sports device 100 is being swung, and emitting the “motion tone,” the motion sensor 120 and processor 130 are working together to also determine whether the total angle of rotation around the longitudinal axis A has changed from its initial ready position by more than a threshold amount in either direction of rotation.

If the total angle has changed by more than the threshold amount, in the illustrated case +/−8 degrees, the processor 130 will trigger the audio device 140 to alter the “motion tone” either upward in pitch or downward in pitch based on the direction of the angle change. The player 2 is then able to translate this change in pitch relative to the “motion tone” into an indication of an imperfect swing. Others will continue to hear the rotation tones, above or below the motion tone, and continue to be notified by the swinging equipment 4. Therefore this combination mode provides both the training function and the safety function. This mode may be used during practices where the player 2 is around others but is also trying to improve their swinging technique.

The processor 130 can be programmed to work with the motion sensor 120 to provide other possible functions as well. For example, the absolute orientation of the sports device 100 can be determined relative to gravity. With this in mind, the sports device 100 can be programmed to help a player 2 position the equipment into a particular preferred initial position as well as provide stimuli concerning motion during the swinging of the equipment.

By taking into account its immediate past motion history, in some embodiments, the processor may be configured to anticipate a swing. In such instanced, the sports device 100 emits the motion tone only during swings, thus providing a targeted safety feature.

In other embodiments, the sports device 100 may be positioned on and mounted to move with a person. The sports device 100 could provide a safety feature to a runner or walker in the dark by emitting the “motion tone” to help alter others of their presence.

As seen in the foregoing description, the present invention provides training of a swing without the use of a camera, or mechanical devices such as tethers and the like, known in the prior art.

It is also contemplated that some embodiments of the sports device 100 may be used to improve the stride of a runner. For example, the sports device 100 (appropriately configured) can be mounted on a dorsal portion of a runner's shoe or foot to monitor pronation or supination (“yaw”) of the foot. This yaw may be manifested in one or more of rotation of the foot relative to the tibia, fibula and/or one or more bones in the ankle. In such case, the sports device creates a first audible signal when the medial yaw (“inward yaw”) exceeds a first predetermined angular extent, and creates a second audible signal distinct from the first audible signal when the lateral yaw (“outward yaw”) exceeds a second predetermined angular extent. It is understood that four different distinct audible signals may be needed on the two devices so that the runner can distinguish between the different yaws on both shoes or feet. Minimizing pronation and supination while running can increase speed and endurance by applying more of the body's energy into forward movement and promote balance. Minimizing pronation and supination of the feet can also reduce strain and injury on foot, ankle, and leg muscles and tendons.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

We claim:

1. A method for assisting an individual to improve his or her swing of an elongated item of sporting equipment having a longitudinal axis extending between a gripping end and a far end of the equipment, the method comprising:
(a) affixing a sports device to the gripping end of the equipment, so that the sports device and the gripping end of the equipment move together, wherein
the sports device is configured to output a first audible signal upon a first rotation of the sports device in a first rotational direction about the longitudinal axis;
the sports device is configured to output a second audible signal upon a second rotation of the sports device in a second rotational direction about the longitudinal axis, the second rotational direction being opposite the first rotational direction; and
(b) swinging the equipment through an arc appropriate to a sport associated with the equipment, while listening for the first or second audible signal; and
(c) adjusting one's swing in response to hearing said first or second audible signal, so as to reduce the likelihood of creating said first or second audible signal, on a subsequent swing.

2. The method of claim 1, wherein affixing the sports device comprises affixing the sports device to the equipment at a position along the longitudinal axis.

3. The method of claim 1, comprising producing one of the first audible signal and the second audible signal only is rotation about the longitudinal axis exceeds 8 degrees relative to a neutral position calibrated prior to swinging.

4. The method of claim 1, comprising affixing the sports device to a griping end of a baseball bat, to train a player not to prematurely rotate his or her wrist during a swing.

5. The method of claim 1, comprising emitting an audible motion signal whenever the equipment is in motion to thereby warn others that an item of equipment is in motion in their immediately vicinity.

6. The method of claim 5, comprising outputting the audible motion signal only when the equipment is being swung by the gripping end.

7. The method of claim 5, comprising selecting from among:
a first mode of operation in which only the first and second audible signals may be produced; and
a second mode of operation in which the first and second audible signals, and also audible motion signal may be produced.

8. The method of claim 5, comprising affixing the sports device to a griping end of a baseball bat

9. A method for warning an individual in the vicinity of an elongated item of sporting equipment having a longitudinal axis extending between a gripping end and a far end of the equipment, that the equipment is in motion, the method comprising:
(a) affixing a sports device to the gripping end of the equipment, so that the sports device and the gripping end of the equipment move together, wherein:
the sports device is configured to output an audible motion signal whenever the sports device undergoes an acceleration greater than a predetermined amount.

10. The method of claim 9, comprising affixing the sports device to the griping end of a baseball bat, to warn individuals nearby that the baseball bat is being swung.

11. The method of claim 10, comprising outputting the audible motion signal only when the baseball bat is being swung by the gripping end.

12. The method of claim 9, comprising outputting the audible motion signal only when the equipment is being swung by the gripping end.

13. The method of claim 9, wherein the sports device is further configured to:
output a first audible signal upon a first rotation of the sports device in a first rotational direction about the longitudinal axis; and
output a second audible signal upon a second rotation of the sports device in a second rotational direction about the longitudinal axis, the second rotational direction being opposite the first rotational direction

14. The method of claim 13, comprising selecting from among:
a first mode of operation in which only the audible motion signal may be produced; and
a second mode of operation in which the audible motion signal and also first and second audible signals, may be produced.

15. The method of claim 13, comprising affixing the sports device to a griping end of a baseball bat

16. A method for informing a runner of excessive pronation or supination of a foot during a stride, the method comprising:
(a) affixing a sports device to a dorsal portion of each shoe or foot of the runner such that the sports device and the shoe or foot move together, wherein each sports device is configured to:
output a first audible signal when a medial yaw of the shoe or foot exceeds a first predetermined angular extent; and
output a second audible signal distinct from the first audible signal, when a lateral yaw of the shoe or foot exceeds a second predetermined angular extent.
